(19) United States
(12) Patent Application Publication
(10) Pub. No.: US 2004/0267703 A1
(43) Pub. Date: Dec. 30, 2004

(54) System and method for accessing medical records

(75) Inventors: Kevin W. McEnery, Sugar Land, TX (US); Charles T. Suitor, Pearland, TX (US); Stanford M. Hildebrand, Katy, TX (US)

Correspondence Address: BAKER BOTTS L.L.P., 2001 ROSS AVENUE, SUITE 600, DALLAS, TX, 75201-2980, US

(73) Assignee: Board of Regents, The University of Texas System

(21) Appl. No.: 10/264,225

(22) Filed: Oct. 2, 2002

(51) Int. Cl. G06F 17/30

(52) U.S. Cl. 707/3

(57) ABSTRACT

A method for accessing data records comprises receiving a query for at least one data record from a client, wherein the client is identifiable by at least one characteristic. The query is parsed into a plurality of parameters. An audit record is automatically created in a searchable database, wherein the audit record comprises at least one parameter and at least one characteristic. The one or more data records are selected based, at least in part, on the query. The selected data records are communicated to the client.

### TECHNICAL FIELD OF THE INVENTION

This invention relates to electronic record systems and, more specifically, to a system and method for accessing medical records.

### BACKGROUND OF THE INVENTION

Medical record systems provide medical enterprises, such as hospitals, electronic access to various medical records. The medical records may include patient records, X-ray images, physician's notes, and other data records. Many current systems follow the Electronic Medical Record (EMR) model of data storage and access. This model requires a copy of all records to be placed into a central archive.

Traditionally, these systems have little security or auditing features. For example, many conventional systems passively audit access to a record by noting the access in a text file or log. This approach is limited in allowing investigation of accessing of such records. In another example, the system does not provide efficient or practical access to the information stored in the audit log. Further, many the current medical record systems do not provide a first user the ability to provide a second user access to records based on the first user's audit trail.

### SUMMARY OF THE INVENTION

One aspect of the invention is a method for accessing data records comprises receiving a query for at least one data record from a client, wherein the client is identifiable by at least one characteristic. The query is parsed into a plurality of parameters. An audit record is automatically created in a searchable database, wherein the audit record comprises at least one parameter and at least one characteristic. The one or more data records are selected based, at least in part, on the query. The selected data records are communicated to the client.

The invention has several important technical advantages. Various embodiments of the invention may have none, some or all of these advantages. One advantage of the invention is that it provides more efficient processing of requests for data records. Another advantage might be a more secure architecture for sensitive data records. Further advantages might include a customizable list of audit entries to aid in a presentation, document medical information accessed in a physician-patient interaction, real-time knowledge of system or data record access, improved collaboration among clients by providing a continuously updated access listing of all clients accessing a specific patient's medical record, and others. Other technical advantages of the present invention will be readily apparent to one skilled in the art.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates a computer system for auditing a record access query in accordance with one embodiment of the present invention;

FIG. 2 illustrates an audit table in accordance with the computer system of FIG. 1;

FIG. 3 illustrates a user role table in accordance with the computer system of FIG. 1;

FIGS. 4A-B illustrate audit lists in accordance with the computer system of FIG. 1;

FIG. 5 is a flow diagram illustrating a method for auditing a record access query in accordance with one embodiment of the present invention; and

FIG. 6 is a flow diagram illustrating a method for creating a customizable audit list in accordance with one embodiment of the present invention.

### DETAILED DESCRIPTION OF EXAMPLE EMBODIMENTS OF THE INVENTION

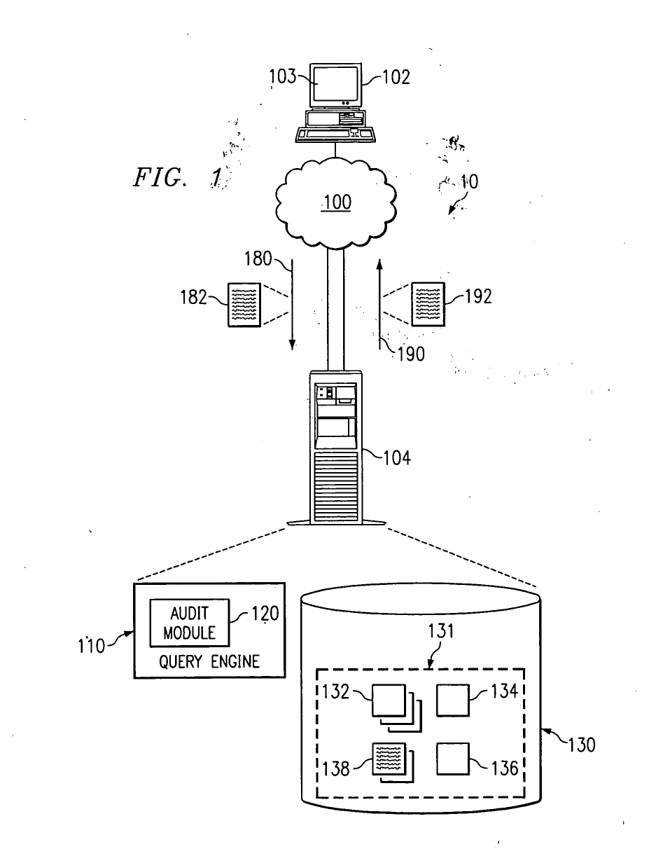

FIG. 1 illustrates a computer system 10 for accessing data records in accordance with one embodiment of the present invention. System 10 includes network 100, one or more clients 102, and one or more servers 104 operable to receive a query 180 from client 102 and initiate communication of a query result 190 to client 102. In this embodiment, query 180 includes parameters 182. Parameters 182 may include a timestamp of the query, an identifier of the table including the one or more requested data records, a sorting identifier, key fields, or any other appropriate data. Query result 190 may be any data record that is communicated in response to a record access query 180 including patient records, X-ray images, physician's notes, and other data records. Other embodiments of system 10 may be used without departing from the scope of this disclosure. In general, the present invention allows efficient and secure auditing of data record access and provides user-friendly access to the audit trail in response to query 180.

Network 100 is coupled to one or more servers 104 and one or more clients 102. Network 100 facilitates wireless or wireline communication between components of system 10. Network 100 may communicate, for example, Internet Protocol (IP) packets, Frame Relay frames, Asynchronous Transfer Mode (ATM) cells, voice, video, data, and other suitable information between network addresses. Network 100 may include one or more local area networks (LANs), radio access networks (RANs), metropolitan area networks (MANs), wide area networks (WANs), all or a portion of the global computer network known as the Internet, and/or any other communication system or systems at one or more locations.

Client computer system 102 may include appropriate input devices, output devices, mass storage media, processors, memory, or other components for receiving, processing, storing, and/or communicating information. As used in this document, the term “computer” is intended to encompass a personal computer, workstation, network computer, kiosk, wireless data port, datashow, wireless telephone, personal digital assistant (PDA), one or more processors within these or other devices, or any other suitable processing device. It will be understood that there may be any number of clients 102 coupled to network 100.

Server 104 comprises an electronic computing device operable to receive, transmit, process and store data associated with system 10. For example, server 104 may comprise a general-purpose personal computer (PC), a Macintosh, a workstation, a UNIX-based computer, a server computer, wireless data port, datashow, or any other suitable device. Server 104 may be operable to communicate with client computers 102. For example, server 104 may communicate with client computers 102 over the network 100. Or, in the alternative, it will be understood that client computer 102 and server 104 may illustrate different modules included in the same computing device.

Server 104 may also be a web server. One function of web server 104 (or a pool of servers) might be to allow a client 102 to send or receive content over or from the Internet using a standard client interface language such as, for example, the Extended Markup Language (XML) or Hypertext Markup Language (HTML). Server 104 can accept query 180 from client 102 via a web browser (e.g., Microsoft Internet Explorer or Netscape Navigator) and return the appropriate HTML documents that may include data from query results 190.

Server 104 includes a query engine 110 and a memory 130. Query engine 110 may be any module that can process a plurality of query results 190 to be communicated in response to query 180. Query engine 110 may receive query 180 from, and communicate query result 190 to, client 102, memory 130, or other suitable modules or devices. Query engine 110 processes query 180 to generate query results 190. Processing query 180 may include parsing query 180 into parameters 182 or any other appropriate processing, as described in greater detail below.

Query engine 110 includes an audit module 120. Audit module 120 may be any module operable to dynamically process an audit of query 180 and an audit list 138. Audit module 120 dynamically retrieves characteristics 103 of client 102, dynamically retrieves parameters 182 of query 180, securely stores the audit results in memory 130 based on characteristics 103 and parameters 182, and provides real-time access to the audit in memory 130. It will be understood that while query engine 110 is illustrated as including audit module 120, the features and functionality performed by these engines may be performed by separate modules or grouped to multi-tasked modules.

Memory 130 may include any memory or database module and may take the form of volatile or non-volatile memory including, without limitation, magnetic media, optical media, random access memory (RAM), read-only memory (ROM), removable media, or any other suitable local or memory component. Further, memory 130 includes tables 131 that may be of any suitable format including XML tables, flat files, comma-separated-value (CSV) files, SQL tables, relational database tables, and others. In this embodiment, tables 131 include medical record tables 132, user role table 134, audit table 136, and audit lists 138.

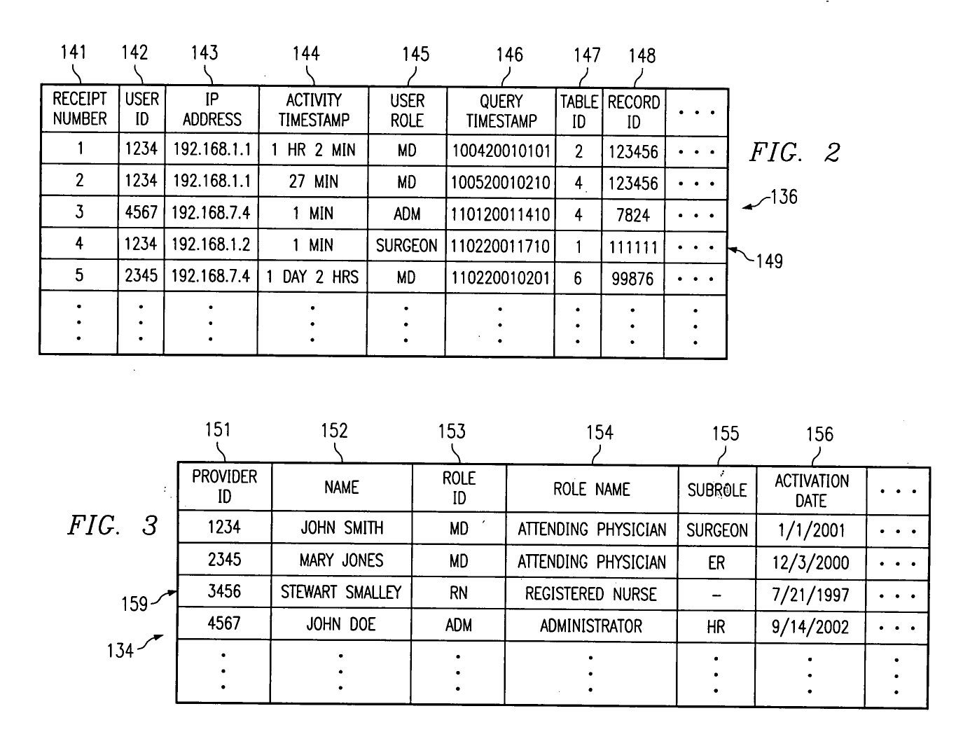

In general, medical record tables 132 may include any suitable medical records including, for example, X-Ray images, patient notes, oncology tests, lab results, and others. User role table 134, described in more detail in FIG. 3, includes a plurality of users of system 10 and any suitable audit or security information. System 10 uses audit table 136, described in more detail in FIG. 2, to store the audit trail of query 180.

In one aspect of operation, client 102 may submit a record access query 180 for processing by system 10. Query 180 may access any table 131 including, but not limited to, medical record tables 132, user role table 134, and audit table 136. Query engine 110 receives characteristics 103 of client 102 including, for example, an IP address, user ID, terminal ID, and others.

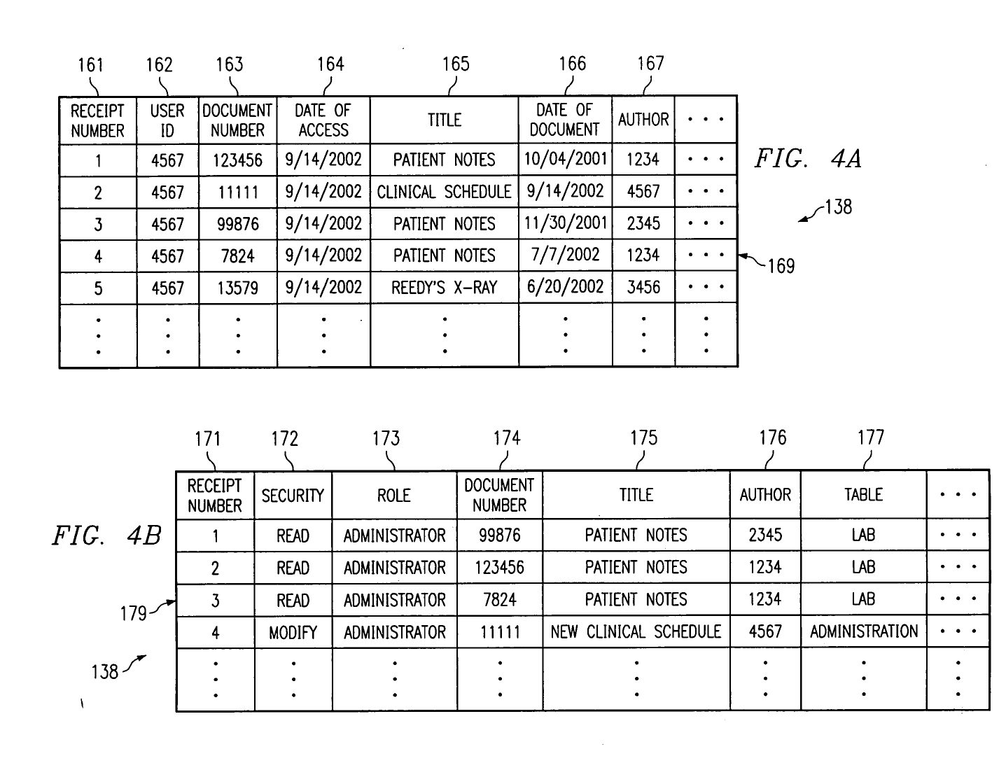

Server 104 then actively audits query 180 using the characteristics 103, parameters 182, and any other appropriate data. This generally involves audit module 120 combining the data and storing the audit results in audit table 136. Further, query engine 110 may verify certain client characteristics 103 to allow or deny access to the data records. Once created, the audit results, stored in audit table 136, are quickly accessible by any client 102, based at least in part, on the client characteristics 103. It will be understood that client 102 may submit a second query 180 to retrieve the audit results of the first query 180, and in such a case the second query 180 is audited as well. Further, audit module 120 may create an audit list 138 that provides client 102 with the ability to create a customizable presentation of the query results 190, as described in more detail in FIGS. 4A-B.

Based on the query 180, query engine 110 retrieves the query result 190. Once query result 190 is retrieved by query engine 110, query engine 110 communicates query result 190 to client 102 through network 100. It should be understood that query result 190 may include any data, including a failure to find suitable results. In an alternative embodiment, a first client 102 submits query 180 for processing by system 10. After processing query 180, server 110 communicates query result 190 to a second client 102. In other words, the client 102 submitting query 180 and the client 102 receiving query result 190 may be the same or different computers.

The dynamic creation of audit records 149 and audit list 13 by system 10 allows client 102 access to data records in a secure environment. Further, the active auditing of query 180 ensures that only clients 102 with proper rights access tables 131. System 10 also allows for audits of queries into the audit table 136, which ensures that access into the audit table 136 may be efficiently monitored.

FIG. 2 illustrates one embodiment of audit table 136 in accordance with the system 10. In general, system 10 may use audit table 136 to securely store and process audits of queries 180. In one embodiment, audit table 136 is a multi-dimensional data structure that includes at least one audit record 149. Each audit record 149 includes multiple columns. In this example, audit record 149 includes a record number 141, a user ID 142, an IP address 143, activity timestamp 144, user role 145, query timestamp 146, table ID 147, and record ID 148. It will be understood that each audit record 149 may include none, some, or all of the example columns. In one embodiment, audit record 149 may include a link to another table, such as, for example, user role 145 may be used to access particular entries of user role table 134. Audit record 149 may also include table ID 147 to access particular entries of a medical record table 132. It should be noted that the audit record 149 may be accessed by record number 141, user ID 142, or any other field.

The example audit records 149 shown in audit table 136 are 3 “1234” records, a “4567” record, and a “2345” record. The audit records 149 illustrated in audit table 136 are merely exemplary. System 10 contemplates any other suitable device to allow for suitable processing of query 180. Moreover, audit table 136 may be separated into multiple tables without departing from the scope of the invention. In one embodiment, audit table 136 and user role table 134 are combined into a user-audit matrix (not shown).

FIG. 3 illustrates one embodiment of the user role table 134 in accordance with the system 10. In general, system 10 may use user role table 134 to efficiently store user characteristics and provide further security. User role table 134 is a multi-dimensional data structure that includes at least one user role record 159. Each user role record 159 includes multiple columns. In this example, user role record 149 includes a provider ID 151, a name 152, a role ID 153, a role name 154, subrole 155, and activation date 156. It will be understood that each user role record 159 may include none, some, or all of the example columns. In one embodiment, user role record 159 may include a link to another table, such as, for example, provider ID 151 may be used to access particular entries of audit table 136. User role record 159 may also include subrole 155 to recursively access a particular entry in user role table 134. It should be noted that user role record 159 may be accessed by provider ID 151, name 152, or any other field.

The example user role records 159 shown in user role table 134 are “John Smith”, “Mary Jones”, “Stewart Smalley”, and “John Doe”. User role records 159 illustrated in user role table 134 are merely exemplary. System 10 contemplates any other suitable device to allow for suitable and secure processing of client characteristics 103. Moreover, user role table 134 may be separated into multiple tables without departing from the scope of the invention.

FIGS. 4A and 4B illustrate different embodiments of audit list 138 in accordance with the computer system 10. In general, system 10 may use audit list 138 to organize audit records for later access, review, and presentation. FIG. 4A illustrates a first audit list 138 that is a multi-dimensional data structure that includes at least one audit entry 169. In one embodiment, first audit list 138 may be a history of records accessed by client 102 for a particular session. Each audit entry 169 includes multiple columns and may represent each audit record 149 for client 102. In this example, audit entry 169 includes a Record Number 161, User ID 162, Document Number 163, Access Date 164, Title 165, Document Date 166, and Author 167. Audit entry 169 may include a link to another table, such as, for example, Document Number 163 may be used to access particular entries of medical record tables 132. It will be understood that each audit entry 169 may include none, some, or all of the example columns.

FIG. 4B illustrates a second audit list 138 that is a multi-dimensional data structure that includes at least one audit entry 179. In one embodiment, second audit list 138 may be a customizable list of records for presentation to client 102. Each audit entry 179 includes multiple columns. In this example, audit entry 179 includes a Record Number 171, Security 172, Role 173, Document Number 174, Title 175, Author 176, and Table 177. The data stored in Record Number 171 may illustrate the order of presentation for records 179. Security 172 may allow or deny a second client 102 to modify second audit list 138. For example purposes only, if entry 179 includes “Read” in Security 172, then second client 102 may not remove entry 179 from second audit list 138. Also, access to second audit list 138 may be limited based, at least in part, on the Role 173 data. It will be understood that each audit entry 179 may include none, some, or all of the example columns.

In one aspect of operation, client 102 selects a first audit entry 169 from first audit list 138. For example, client 102 selects Record Number “3” from exemplary first audit list 138 in FIG. 4A. The selected entry 169 is used to create an entry 179 in second audit list 138. Returning to the example, Document Number 174 links to Document Number 163, Title 175 links to Title 165, Author 176 links to Author 167, and Record Number “1” is created in exemplary second audit list 138 in FIG. 4B. Client 102 may select one, some, or all of entries 169 in first audit list 138 to create entries in second audit list 138. In another example, client 102 selects Record Number “2” in first audit list 138. System 10 creates entry “4” in second audit list 138, where client 102 customizes the data in Title 175.

Generally, audit list 138 provides a dynamic history of the data records accessed by client 102. Audit list 138 may be quickly customized to organize or remove records for a presentation. For example purposes only, first client 102 may receive first audit list 138 for the appropriate query 180 session, remove sensitive audit list entries 169, and forward the second audit list 138 to second client 102.

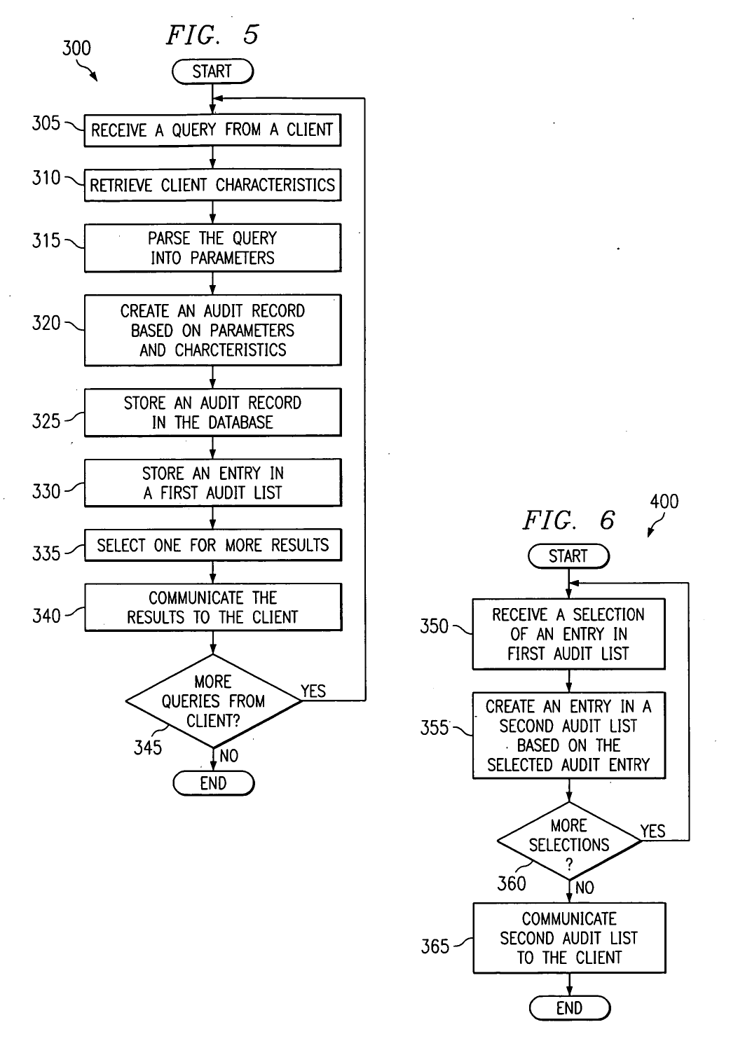

FIG. 5 is a flow diagram illustrating a method 300 for auditing a query 180 in accordance with one embodiment of the present invention. Method 300 may be described with respect to system 10 of FIG. 1. Any other suitable system may use method 300 to audit query 180 without departing from the scope of this disclosure.

A query 180 from client 102 is received at server 104 in step 305. It should be understood that the query 180 will include one or more parameters 182. Once the query 180 is received, query engine 110 receives the characteristics of the client 102 at step 310. For example, the characteristics may include a User ID, an IP address, a terminal ID, or any other information capable of uniquely identifying the client 102. Query engine 110 then parses query 180 into parameters 182 at step 315. Generally, parsing query 180 includes breaking the query 180 into audit information, such as time of query, and query information, such as record number or table ID. However, parsing the query may further include drilling-down on parameters 182 or any other processing suitable for this invention. Execution proceeds to steps 320-330 where query 180 is actively audited.

At step 320, audit engine 120 begins processing the audit information from query 180 and creates audit record 149. The audit information may include characteristics 103, parameters 182, and any other appropriate information. Then, at step 325, audit record 149 is stored in audit table 136. This new audit record 149 may be real-time accessible to any appropriate client 102. Next, audit engine 120 stores an audit entry 169 in a first audit list 138 at step 330. As described above, audit list 138 is a listing of the records and tables viewed by client 102. In one embodiment, first audit list 138 may include a history of records viewed during one time period, such as a login timeframe, or a history of records viewed for one patient by different users involved in the care of the patient.

Execution proceeds to step 335, where query engine 110 selects one or more query results 190 from memory 130. Query engine then communicates query results 190 to client 102. It will be understood that the final query result 190 may include any suitable data, including a wide variety of images, documents, audit information, and other appropriate data. At decisional step 345, it is determined whether there are more queries 180 from client 102. If there remain any additional queries 180, execution returns to step 305. Otherwise, the query processing ends.

Although FIG. 5 illustrates one example of a method 300 of auditing query 180, various changes may be made to method 300 without departing from the scope of this disclosure. Also, while FIG. 5 illustrates decisional step 345, other and/or additional decisional steps may be used in method 300.

FIG. 6 is a flow diagram illustrating a method 400 for creating a customizable audit list 138 in accordance with one embodiment of the present invention. As described above in reference to FIG. 5, any suitable system may use method 400 to create customizable audit list 138 without departing from the scope of this disclosure.

At steps 350-360, audit engine 120 creates a customizable second audit list 138. At least one audit entry 169 is selected from first audit list 138 at step 350. The selected entry 169 is used to create an audit entry 179 in second audit list 138 at step 355. Further, while not shown, it should be understood that client 102 may customize, by reorganizing or other modifications, second audit list 138 using any suitable processes at any appropriate time.

At decisional step 360, execution returns to step 350 if more audit entries 169 are selected from first audit list 138. Once the creation and customization of second audit list 138 is complete, server 104 communicates second audit list 138 to client 102 at step 365. In one embodiment, a first client 102 submits query 180 for processing by system 10. After processing query 180 and the audit lists 138, as shown in FIGS. 5 and 6, server 104 initiates communication of second audit list 138 to a second client 102. In other words, the client 102 submitting query 180 and the client 102 receiving second audit list 138 may be the same or different clients 102.

Although FIG. 6 illustrates one example of a method 400 of creating a customizable audit list 138, various changes may be made to method 400 without departing from the scope of this disclosure. Also, while FIG. 6 illustrates decisional step 360, other and/or additional decisional steps may be used in method 300.

Although the present invention has been described in detail, it should be understood that various changes, substitutions and alterations can be made hereto without departing from the sphere and scope of the invention as defined by the appended claims.

To aid the Patent Office, and any readers of any patent issued on this application in interpreting the claims appended hereto, applicants wish to note that they do not intend any of the appended claims to invoke ¶ 6 of 35 U.S.C. § 112 as it exists on the date of filing hereof unless the phrase “means for” is used in the particular claim.

What is claimed is:

1. A method for accessing data records comprising:
receiving a query for at least one data record from a client, wherein the client is identifiable by at least one characteristic;
parsing the query into a plurality of parameters;
automatically creating an audit record in a searchable database, wherein the audit record comprises at least one of the parameters and at least one of the characteristics;
selecting the one or more data records based at least in part on the query; and
initiating communication of the selected data records to the client.

2. The method of claim 1, wherein the one or more characteristics comprise:
a user ID;
an IP address;
a user role; and
a security role.

3. The method of claim 2, wherein the client role comprises a job category or a job location.

4. The method of claim 1, wherein the parameters comprise:
a timestamp of the query;
an identifier of the table including the one or more requested data records; and
a sorting identifier.

5. The method of claim 1, wherein the data records comprise medical records.

6. The method of claim 1, wherein the query comprises a first query for a first set of data records, the audit record comprises a first audit record, and the method further comprises:
receiving a second query for a second set of data records from the client;
parsing the second query into a second plurality of parameters;
automatically creating a second audit record in the searchable database;
selecting the one or more data records based at least in part on the second query; and
communicating the second selected data records to the client.

7. The method of claim 6, further comprising creating a real-time audit list, wherein the audit list comprises a first audit entry linked to the first audit record and a second audit entry linked to the second audit record.

8. The method of claim 7, wherein the audit list comprises a first audit list and the method further comprises:
selecting at least one audit entry from the first audit list; and
creating a second audit list, wherein the second audit list comprises the selected audit entries.

9. The method of claim 8, wherein the client comprises a first client and the method further comprises communicating the second audit list to a second client.

10. The method of claim 1, wherein the data records comprise audit records.

11. The method of claim 1, further comprising:
comparing the security role characteristic of the client to the security role of each selected data record; and
in response to the security role characteristic of the client being less than the security role of each selected audit record, deselecting the selected data record.

12. A system for accessing data records comprising:
logic encoded in media; and
the logic is operable when executed to:
receive a query for at least one data record from a client, wherein the client is identifiable by at least one characteristic;
parse the query into a plurality of parameters;
automatically create an audit record in a searchable database, wherein the audit record comprises at least one parameter and at least one characteristic;
select the one or more data records based at least in part on the query and initiate communication of the selected data records to the client.

13. The system of claim 12, wherein the characteristics comprise:
a user ID;
an IP address;
a user role;
an activity timestamp; and
a security role.

14. The system of claim 13, wherein the client role comprises a job category or a job location.

15. The system of claim 12, wherein the parameters comprise:
a timestamp of the query;
an identifier of the table including the one or more requested data records; and
a sorting identifier.

16. The system of claim 12, wherein the data records comprise medical records.

17. The system of claim 12, wherein the query comprises a first query for a first set of data records, the audit record comprises a first audit record, and the logic is further operable when executed to receive a second query for a second set of data records from the client, parse the second query into a second plurality of parameters, automatically create a second audit record in the searchable database, select the one or more data records based at least in part on the second query, and communicate the second selected data records to the client.

18. The system of claim 17, wherein the logic is further operable when executed to create a real-time audit list, wherein the audit list comprises a first audit entry linked to the first audit record and a second audit entry linked to the second audit record.

19. The system of claim 18, wherein the audit list comprises a first audit list and the logic is further operable when executed to select at least one entry from the first audit list and create a second audit list, wherein the second audit list comprises the selected audit entries.

20. The system of claim 19, wherein the client comprises a first client and the system further comprises communicating the second audit list to a second client.

21. The system of claim 12, wherein the data records comprise audit records.

22. The system of claim 12, wherein the logic is further operable when executed to compare the security role characteristic of the client to the security role of each selected data record and, in response to the security role characteristic of the client being less than the security role of each selected audit record, deselect the selected data record.

23. A method for creating a customizable audit list comprising:
receiving a first query for at least one data record from a client;
creating a first audit record based, at least in part, on the first query;
receiving a second query for at least one data record from the client;
creating a second audit record based, at least in part, on the second query;
dynamically creating a first audit list, wherein the audit list comprises a first audit entry linked to the first audit record and a second audit entry linked to the second audit record;
selecting at least two audit entries from the first audit list; and
storing the selected audit entries in a second audit list.

24. The method of claim 23, further comprising initiating communication of the second audit list to the client.

25. The method of claim 23, further comprising removing an audit entry from the second audit list.

26. The method of claim 23, wherein the audit entries comprise a record number and the method further comprises ordering the audit entries from the second audit list based, at least in part, on the record number.
